(19) United States
(12) Patent Application Publication
(10) Pub. No.: US 2007/0230915 A1
(43) Pub. Date: Oct. 4, 2007

(54) Recording device

(76) Inventors: Jay Nijjer, Bellevue, WA (US); Beverley Elizabeth Alexandra Ward, Birmingham (GB); Lee White, Kirkland, WA (US)

Correspondence Address: BLACK LOWE & GRAHAM, PLLC, 701 FIFTH AVENUE, SUITE 4800, SEATTLE, WA, 98104, US

(21) Appl. No.: 11/357,316

(22) Filed: Feb. 17, 2006

Related U.S. Application Data
(60) Provisional application No. 60/655,586, filed on Feb. 22, 2005.

(51) Int. Cl. H04N 5/91

(52) U.S. Cl. 386/107

(57) ABSTRACT

A microprocessor-based video and audio data recorder configured to store vehicular related data arising from a vehicular accident or incident in a format retrievable from the device.

### PRIORITY CLAIM

This application claims priority to and herein incorporates by reference in its entirety U.S. Patent application No. 60/655,586 filed Feb. 22, 2005.

### FIELD OF THE INVENTION

Accident recording devices.

### BACKGROUND OF THE INVENTION

It is a well known problem in the insurance industry that contemporaneous data (and corresponding usable evidence) are often unavailable in the event of an incident. The need to record such data is most keenly felt in road traffic accidents (RTAs) where it is usual for the traffic involved in the accident to be moved from the scene to ensure that the carriageway can be used by other traffic. In incidents where there is no human casualty, it is not necessary to report the incident to the police because the settlement of the matter is dealt with under civil law. In such cases, the parties involved provide statements to their respective insurance companies outlining the events as they see them. Accordingly, insurance claims are susceptible to an incomplete or inaccurate reporting of the facts. This may be due to the poor memory of the reporting party or because one or all parties may choose the facts they present in order to promote a more favorable view of the incident.

On-board devices for vehicles have been proposed which record data pertaining to an incident for later downloading and investigation. However, such devices are relatively expensive and, if they are not installed during production, must be retrofit to vehicles with all the associated costs and difficulties. Accordingly, such systems have had very limited take-up outside of the emergency services.

US 2002/0181956 discloses an automobile accident recording kit that comprises a single use (disposable) camera with a set of forms for recording information pertaining to an accident. The forms designate the views required as well as indicating other information that should be recorded (witness names, insurance details and so on). The kit is designed to be kept in the glove compartment of a vehicle. While such a kit may be useful, there is a risk that such a kit may lose parts or may become damaged.

Accordingly, there is a need to provide a portable means to record data related to an automobile accident or incident.

### SUMMARY OF THE INVENTION

This invention relates to a recording device to a recording device configured to record visual and audio data in the aftermath of a vehicle accident or incident as occurs with automobiles and other forms of transportation. The data that recorded has a highly probative value of particular use to insurance companies in helping establish or resolve insurance claims to damaged vehicles, personal injury to vehicle occupants, and non-accident incidents as occurs with theft, vandalism, and vehicle impoundments.

Particular embodiments of the device includes a housing or case having a power supply that powers a built-in camera, a microphone, a microprocessor, a memory unit, a data retrieval conduit, and user controls. Upon the occurrence of a vehicle accident or incident, the user manipulates the controls to send operate the microphone and camera that send audio and visual information to the microprocessor. The microprocessor processes the audio and visual data to a format amenable to vehicular accident and non-accident incidents and stores the formatted data to the memory unit. Retrieval of the formatted data to analog and digital devices is achieved through the data retrieval conduit.

### BRIEF DESCRIPTION OF THE DRAWINGS

Preferred and alternative embodiments of the present invention are described in detail below with reference to the following drawings.

FIG. 1 is a photograph of an automobile engageable with a key fob;

FIG. 2 is a depiction of a car dealer-supplied key fob;

FIG. 3 is a depiction of the car dealer-supplied key fob with multiple keys attached;

FIG. 4 is another depiction of the car dealer-supplied key fob with multiple keys attached;

FIG. 5 illustrates business activity at a car dealership;

FIG. 6 illustrates a push button side of an electronic key fob of a particular embodiment used as a vehicle incident assistant;

FIG. 7 is an example of a promotional statement for the electronic key fob;

FIG. 8 depicts a transportation incident recordable by the electronic key fob;

FIG. 9 illustrates a promotional statement for the electronic key fob;

FIG. 10 illustrates a back side of the vehicle incident assistant electronic key fob;

FIG. 11 illustrates another promotional statement for the electronic key fob;

FIG. 12 illustrates the back side of the vehicle incident assistant electronic key fob with another promotional statement;

FIG. 13 illustrates another promotional statement bracketing a side-by-side comparison view of the dealer-supplied fob and the vehicle incident assistant electronic key fob; and

FIG. 14 is a photograph of an automobile engageable with the vehicle incident assistant electronic key fob.

### DETAILED DESCRIPTION OF THE PARTICULAR EMBODIMENTS

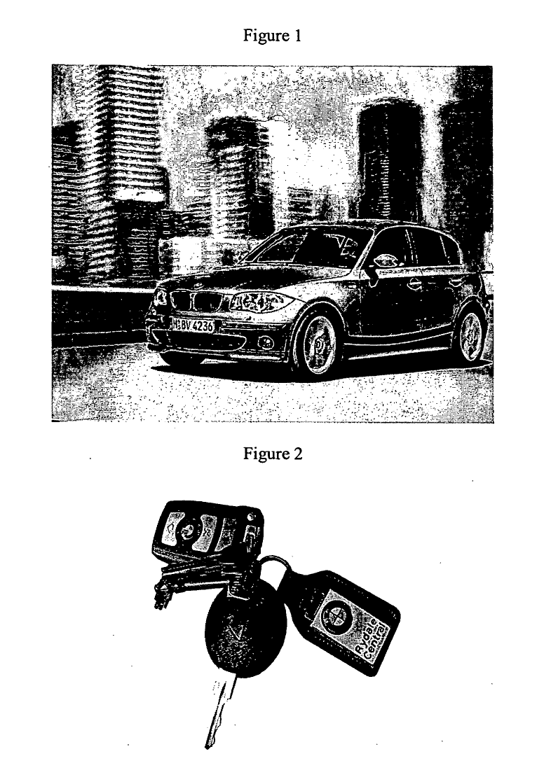

The particular embodiments provide for a recording key fob device configured to record data related to vehicle related incidents. FIG. 1 is a photograph of an automobile engageable with a key fob device and would benefit from having visual, audio, and alphanumeric data recorded as vehicle-related information. For example, the recording of incident data relating to an automobile's operation or by engagement with the automobile. The data recorded has significant probative value in the event of an automobile collision incident, a theft incident, or a passenger or driver incident that would be used in addressing an insurance claim and/or any dispute relating to such a claim. A particular embodiment of the device includes a vehicle incident assistant that stores vehicle and vehicle accident or vehicle incident related data.

FIG. 2 is a depiction of a car dealer-supplied key fob that lacks the ability to record and store vehicle incident information and attached with multiple keys. The dealer-supplied models have other disadvantages in that the identifying tag showing the name of the dealership where the car was purchased has fallen off or has been removed.

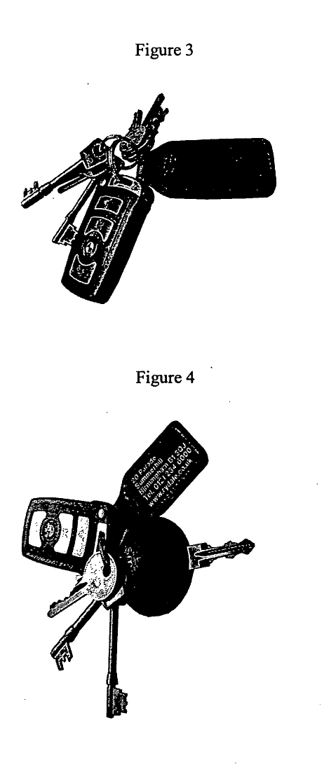

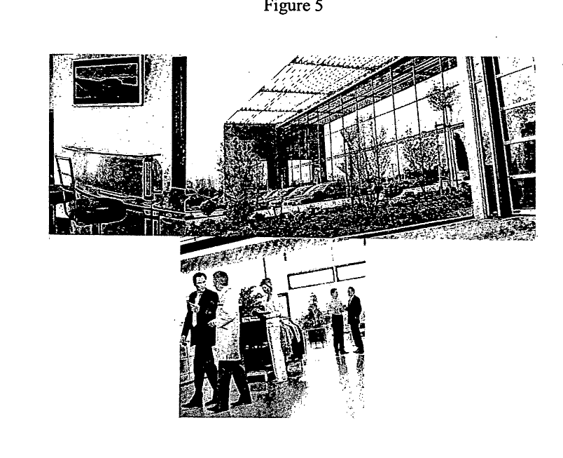

FIGS. 3 and 4 present more depictions of the car dealer-supplied key fob further burdened with yet more multiple attached keys. The auto dealer printed information is located on the back of the fob. Though functional, the printing on the back plate does not optimally promote an auto dealership than it would if it were printed on the front plate of the fob.

FIG. 5 illustrates business activity at a car dealership intent on developing satisfied customers using a recording key fob device.

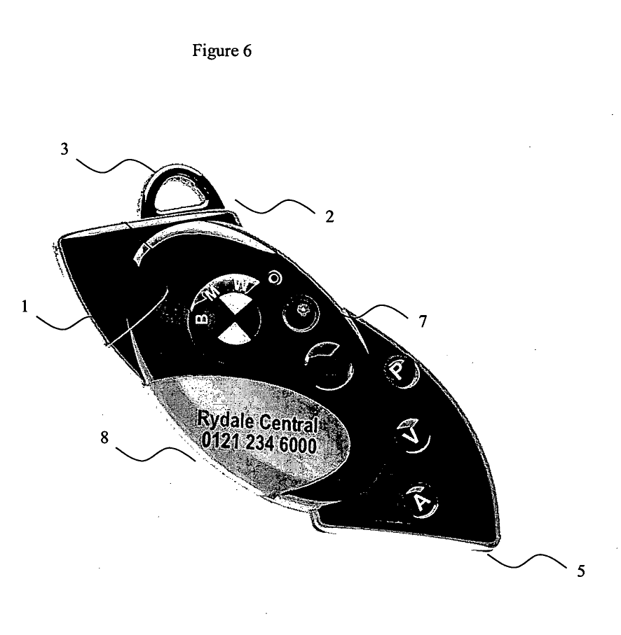

FIG. 6 illustrates a push button side of an electronic key fob 1 of a particular embodiment used as a vehicle incident assistant. The vehicle incident assistant would be given to car dealership customers as illustrated in FIG. 5 to encourage automobile sales. Preferred embodiments of the electronic key fob would includes a vehicle's logo and operational push buttons located on the front face plate of the fob. The push buttons effect visual, audio, and alphanumeric data recording. In a particular embodiment, the vehicle incident assistant can record audio, video and take pictures and hold all a customer's keys. In another particular embodiment, a screen is connected with the case of the fob to display stored information, e.g. emergency and service agent telephone numbers.

Referring again to FIG. 6, the vehicle incident assistant electronic fob 1 provides for recording data pertaining to an incident associated with automobiles. The electronic fob further includes a key ring to hold one or more attachable keys, a body in having a camera and a power source for the camera, and a means arranged to allow data recorded by the camera to be accessed by an authorized person and to prevent or at least inhibit access by an unauthorized person.

A second aspect of the invention provides a method of providing visual data pertaining to the aftermath of an incident, the method comprising taking visual images of the aftermath of an incident with a camera located in the body of a key fob and providing the key fob to an authorized person to access the so-recorded visual data.

The camera may be arranged to take photographs and/or a video clip.

Preferably, data relating to the time and date that the data was recorded by the camera (e.g. the time each photograph was taken or the start time of the video clip) is recorded with said recorded data and is arranged to be imprinted on the exposed visual data (photograph or video clip).

The fob may comprise a viewfinder to facilitate the framing of visual data (e.g. video clip or photograph).

The body of the fob may also carry a microchip and a microphone usable to record voice or other sound data pertaining to the incident.

The microchip may be the storage medium on which both sound and visual data are recorded or recordable. If so, the total amount of recorded or recordable data will be limited by the storage capacity of the microchip. If both sound and visual data are to be recorded, the microchip may be partitioned to ensure that a minimum amount of space is available to record required visual data and a minimum amount of space is available to record required sound data, the or any excess space preferably being available for the recording of either sound or visual data.

Preferably, the fob is operable to change between ‘voice’ and ‘picture’ mode by a switch mounted on or in the body of the fob.

Preferably, the power source will be changed or at least checked at intervals. Advantageously, the checking and/or replacing may be completed by an authorized agent when the vehicle is, say, serviced or subsequent to use of the camera and/or sound recording chip.

The storage medium may hold pre-recorded data, such as the insurance details of the owner, details of a suitable or approved vehicle repairer or other personal information (blood group, doctor's name, details of the next of kin, and so on). The pre-recorded data may be displayable on a visual display mounted on or in the fob.

A further aspect of the invention provides apparatus for recording data pertaining to an incident, the apparatus comprising a key fob to which one or more keys are attachable, the fob having a body in which is located a microphone and a microchip for recording sound data recorded using the microphone and including means arranged to allow data recorded by the microphone to be accessed by an authorized person and to prevent or at least inhibit access by an unauthorized person.

A yet further aspect of the invention provides a method of providing a report as evidence of an incident, for example in support or defense of an insurance claim, an accusation by the police and so on, the method comprising recording visual and/or sound data pertaining to the incident using recording apparatus located in a key fob, extracting the recorded data and using the extracted recorded data to fabricate a report on the incident.

Preferably, only a person authorized by the fob manufacturer and/or insurance company dealing with the claim can extract the data and provide the report.

A fifth aspect of the invention provides a key for recording data pertaining to an incident, the key having a shaft and a head, the head having a body in which is located a camera and a power source for the camera and including means arranged to allow data recorded by the camera to be accessed by an authorized person and to prevent or at least inhibit access by an unauthorized person.

In order that the invention may be more fully understood, it will now be described, by way of example only and with reference to the accompanying drawing which shows a plan view of a key fob of the current invention.

Referring again to FIG. 6 is the electronic fob 1 having at one end 2 a key ring 3 extending from the end 2. The key ring 3 consists of one or more windings of sprung metal, and hold one or more keys (not shown). The electronic fob 1 will typically be of the same size and shape as conventional key fobs, say 5-10 cm long, 2 to 3 cm wide and 0.5 to 1.5 cm thick, preferably about 6×3.5×0.75 cm. Other particular embodiments of the electronic fob 1 may be smaller or larger than the typical dimensions.

Located within the body of the fob 1 is a camera (not shown), typically a low resolution (e.g. 176×144 pixels) digital camera with limited storage capacity for taking and recording, say, 8 to 20 pictures. Additionally or alternatively, the camera may be able to record a video clip.

A viewfinder 4 is located at the distal end 5 of the fob 1 to facilitate the framing of a photograph or video clip. The lens of the camera (not shown) is mounted on the obverse side of the fob 1.

At least one battery (not shown) is mounted within the body of the fob 1 and is arranged to power the camera to allow the photographs or video clip to be taken and to store the corresponding data. The battery also powers an on-board clock (not shown), which is used as a reference to record the time and date each photograph, or video clip is taken.

The fob also comprises a multi-function push button 7 to operate the device and a visual display 8 to indicate the mode of operation.

The fob 1 also has a microphone 9 operably connected to a processing arrangement, for example a microchip (not shown), arranged to record sounds detected by the microphone 9 on an on-board memory or memory external to the microchip.

In use, and subsequent to an accident or other recordable incident occurring, the operator pushes the pushbutton 7 until the appropriate mode is shown on the visual display 8 (“Photo” being indicated in the Figure). The operator may then frame a photograph or video clip using the viewfinder 4 and take the photograph or video clip by pushing the button 7. The data corresponding to the photograph or video clip will be stored together with the time and date at which the photograph or video clip was taken. The operator will continue taking photographs or video clip(s) until the storage capacity of the device has been exhausted or he has taken sufficient photographs or long enough video clip(s) to give an accurate representation of the incident.

The pushbutton 7 may then be held down until the visual display 8 displays “Voice” and the operator may record a short audio clip, say one of two minutes (longer audio clips may be provided for). The audio clip may also be time and date marked.

The operator may choose to record an audio clip of any or all of the insurance details of any other party, an oral description of the accident or incident, the names, addresses and testimony of witnesses or other pertinent information.

The data corresponding to the pictures (visual data) and sound (audio data) will be stored on a microchip. It is evident that the storage capacity of the microchip will determine the sum of visual and audio data that is recordable. The chip may be partitioned to provide a certain amount of space for visual data and a certain amount of space for audio data, thereby ensuring that a minimum number of photos are recordable and a minimum length of sound is recordable. The sum of the partitioned areas may or may not equal the storage capacity of the microchip. If the latter is true then the excess space may be used to record visual and/or audio data.

Once the data is or are recorded, the fob 1, in one embodiment of the invention, is taken to an authorized agent who will provide a report containing the video clip and/or photographs and a transcript of any recorded audio data. The report can then be used in support or defense of an insurance claim, accusation by the police or so on. Typically, the agent will be a third party authorized by the manufacturer of the fob 1 and/or the supplier of the fob (which may be an insurance company). One suitable agent will be a mechanic, authorized or approved by the fob manufacturer and/or insurance company. This will then provide an opportunity for the mechanic to quote for the repair work in the event of the vehicle being damaged in the incident.

In another embodiment of the invention, the data held on the key fob is downloaded or downloadable by the owner of the vehicle onto their own or another PC using data retrieval software, optionally, approved by the fob manufacturer and/or insurance company.

Downloading of the information may necessitate destruction of the fob 1, i.e. the fob 1 may comprise a sealed plastic body which must be destroyed to access the data chips. In other embodiments, the data may be recorded in encrypted fashion to prevent unauthorized access and/or tampering.

Data may be downloaded using a port (not shown) provided on the fob 1, or via the key ring 3, or via an infrared emitter (not shown) provided on the fob 1.

Accordingly, the fob 1 is able to provide contemporaneous evidence of the aftermath of an incident. Because the time and date is imprinted on the photographs, factors leading up to the incident will be determinable (e.g. amount of road traffic, weather and light conditions) if not discernible from the visual evidence.

It will be appreciated that the fob 1 will find particular utility in RTAs but it may also be useful to record the scene of a break-in either to a vehicle or to a building.

The body of the fob 1 may carry indicia, say advertising information, information pertaining to the owner of the keys or the vehicle, information pertaining to the owner's insurance company and so on.

Preferably, the battery or batteries will be replaced each time the vehicle is serviced or at other pre-determined intervals.

The data held within the fob will be wiped or replaced (for pre-recorded personal data) at every service.

It is clear that the fob 1 is useful to record data pertaining to an incident. Because the fob 1 is, typically, attached to car keys it is always be at hand during an RTA involving the owner.

In accordance with another embodiment, one or more of the above-discussed features (e.g. camera, microphone, microchip, battery, means to download the data) may be provided in the head of a key, for example a vehicle key. In such an embodiment, data can be retrieved via a ward of the vehicle key or another means of interacting with an “ignition” of a vehicle to start the engine of the vehicle, for example an infrared port.

As an added security measure, a vehicle or the fob 1 (or the key) may have a radio-frequency transmitter, the other having a corresponding receiver. If the two are not in close proximity (e.g. the fob 1 is not within the vehicle, or the key is not in the ignition) the vehicle will not start and additionally or alternatively will send a signal to a further receiver indicating that the vehicle is being driven by an unauthorized person.

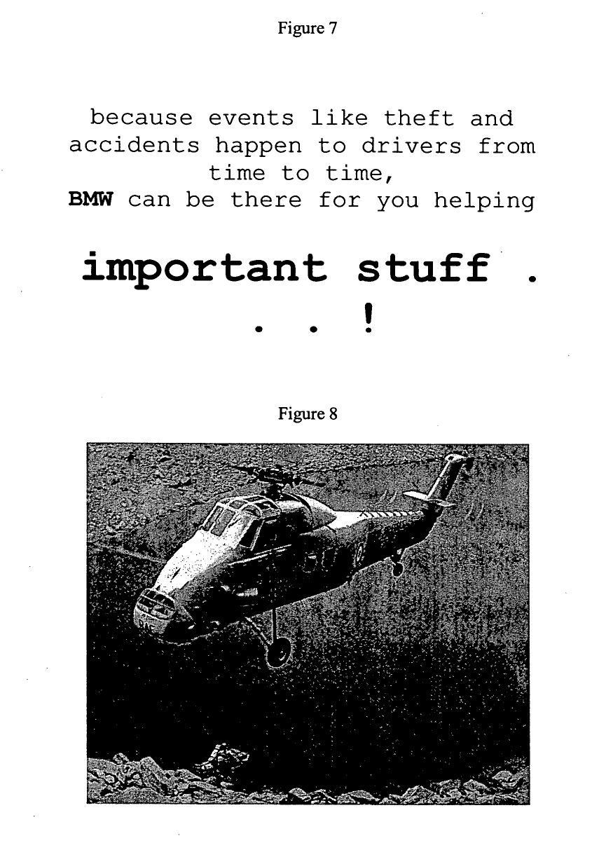

FIG. 7 is an example of a promotional statement for the electronic key fob. A given auto brand may distinguish itself over other brands by having an electronic key fob available with the automobile to help a user record audio, visual, and textual data related to a vehicle incident.

FIG. 8 depicts an exaggerated transportation incident to dramatize vehicular situations recordable by the electronic key fob 1. The emergency rescue by a hovering helicopter depicted brings to mind that severe automobile accidents do happen and occupants of the automobiles require rescue by ambulances, and in some cases, helicopters. Audio, visual, and alphanumeric data of routine to dramatic incidents are recordable by the electronic key fob.

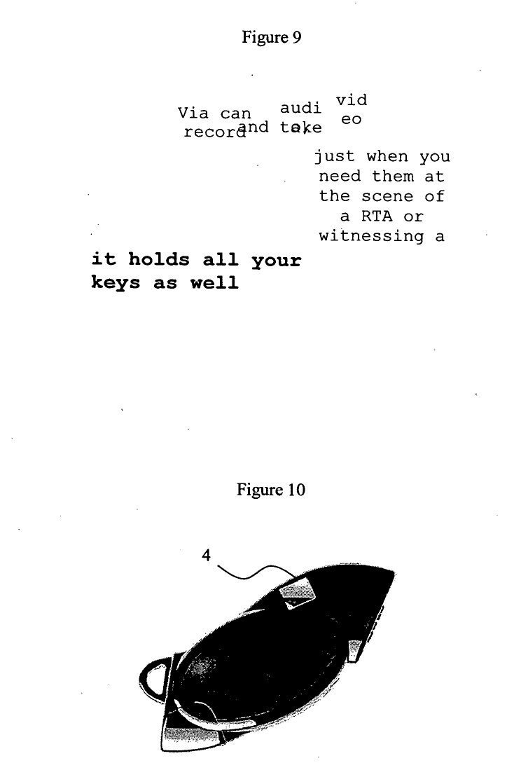

FIG. 9 illustrates a promotional statement for the electronic key fob. The promotional statement emphasizes the major features that a car dealership would be interested in to help distinguish an automobile brand over another or to help market a particular automobile dealership.

FIG. 10 illustrates a back side of the vehicle incident assistant electronic key fob. The camera viewfinder 4 is shown.

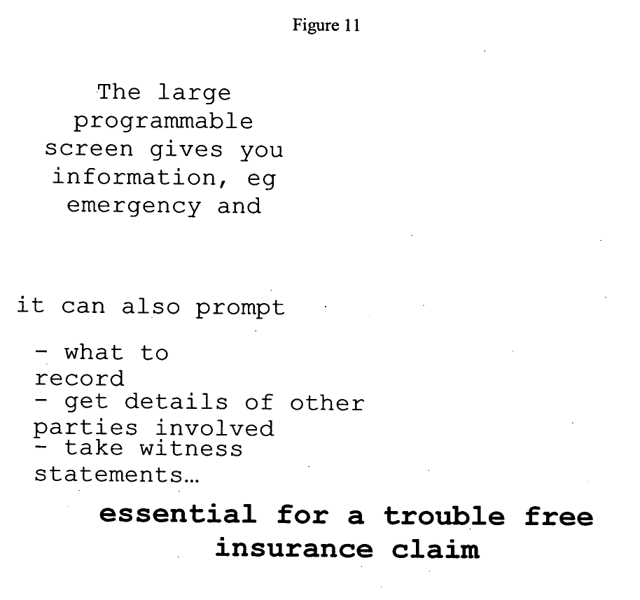

FIG. 11 illustrates another promotional statement for the electronic key fob. The promotional statement emphasizes the alphanumeric information that is presented on the programmable screen of the electronic key fob. Emergency contact numbers and service agent numbers may be displayed. Alternatively, prompts may be presented to remind what should be recorded, for example, audio recording or image recordings as would occur with securing a witness statement for a particular vehicular incident or accident.

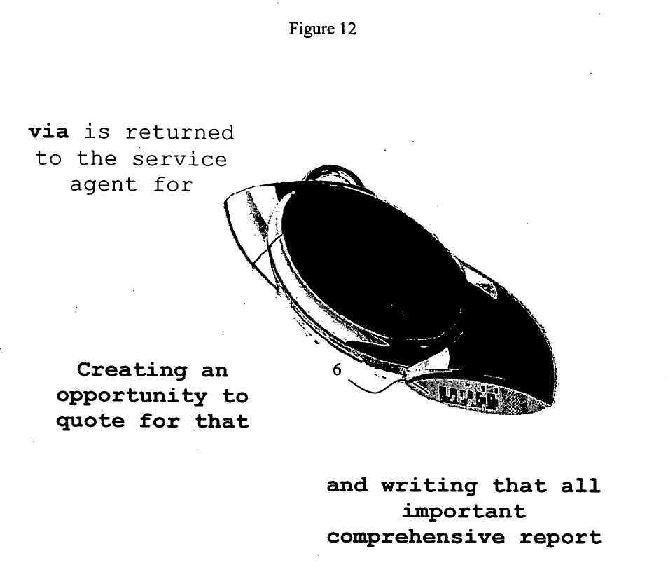

FIG. 12 illustrates the backside of the vehicle incident assistant electronic key fob with another promotional statement providing additional examples of the uses of the electronic key fob. Information may be downloaded from a service agent to receive repair quotes and to generate comprehensive incident reports. Also shown is a connecting port 6 where a service agent can download or otherwise retrieve all of the relevant information stored in memory on the device.

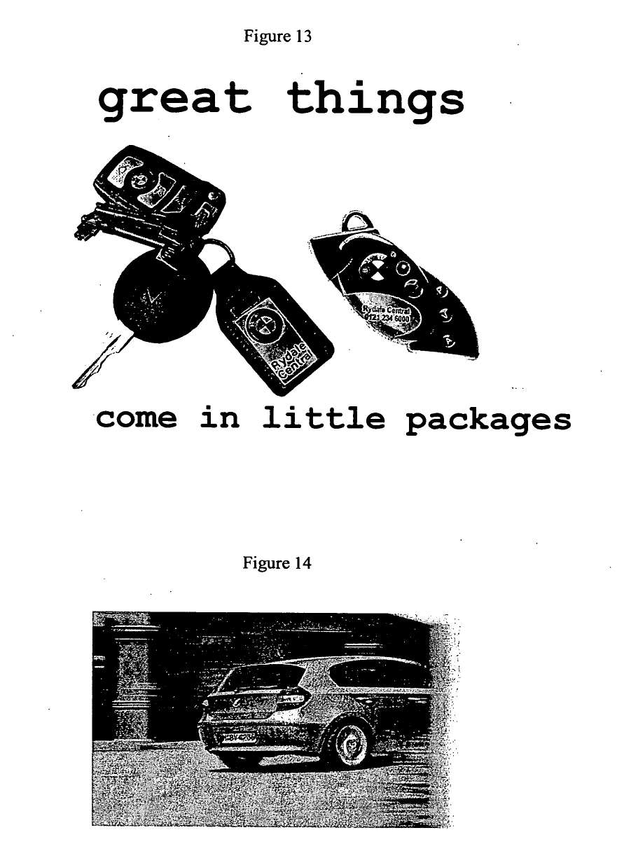

FIG. 13 illustrates another promotional statement bracketing a side-by-side comparison view of the dealer-supplied fob and the vehicle incident assistant electronic key fob. Great things do come in small packages in that the electronic key fob does much more with its image, audio, and text recordation capabilities to in situ document vehicular incidents. This ability for in situ documentation by the electronic key fob 1 is achieved in a smaller size than the non-recording key fobs currently supplied by dealerships.

FIG. 14 is a photograph of another automobile engageable with the vehicle incident assistant electronic key fob.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A data recorder device comprising:
a case having a power supply, a camera component, a microphone component, a memory component; a microprocessor component in communication with the camera, the microphone, and the memory and further configured to receive and process visual and audio vehicular data from the camera and microphone;
a plurality of controls operable by a user and in communication with the camera, microphone, and memory;
a power supply housed in the case and powering the components and controls;
wherein the user operates the controls to send the visual and audio vehicular data generated to the microprocessor for documenting a vehicle accident or non-accident incident in a format retrievable from the memory.

2. The device of claim 1 further having a conduit wherein the data in memory is retrievable by analog and digital devices through the conduit.

3. The device of claim 2 further having a key ring.
